(19) United States
(12) Patent Application Publication
(10) Pub. No.: US 2010/0094941 A1
(43) Pub. Date: Apr. 15, 2010

(54) INFORMATION PROCESSING METHOD, ELECTRONIC MAIL PROCESSING METHOD, INFORMATION PROCESSING APPARATUS, ELECTRONIC MAIL PROCESSING APPARATUS AND COMPUTER READABLE MEDIUM

(75) Inventor: Akira KUROSAWA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/467,330

(22) Filed: May 18, 2009

(30) Foreign Application Priority Data
Oct. 9, 2008 (JP) 2008-263269

(51) Int. Cl. G06F 15/16

(52) U.S. Cl. 709/206; 709/217

(57) ABSTRACT

An information processing method for acquiring entity information or reference information including information for specifying the entity information, the method includes: outputting the entity information when accepting an output request for outputting the entity information;
generating necessity information indicative of an extent of a necessity for outputting the entity information based on a history of the output request fox outputting the entity information; and outputting the reference information including the information for specifying the entity information or the entity information when accepting a request for outputting information relating to the entity information. The outputting step i) outputs the reference information including the information for specifying the entity information when the necessity information for the entity information does not satisfy a predetermined condition and ii) outputs the entity information when the necessity information for the entity information satisfies the condition.

### CROSS-REFERENCE TO RELATED APPLICATIONS

This application is based on and claims priority under 35 U.S.C. 119 from Japanese Patent Application No. 2008-263269 filed Oct. 9, 2008.

### BACKGROUND

1. Technical Field

The present invention relates to an information processing method, an electronic mail processing method, an information processing apparatus, an electronic mail processing apparatus and a computer readable medium.

2. Related Art

There is a technique for outputting reference information including information for specifying entity information, accepting an output request for the entity information specified by the reference information and outputting the entity information to a request source thereof.

### SUMMARY

According to an aspect of the invention, an information processing method for acquiring entity information or reference information including information for specifying the entity information, the method includes: outputting the entity information when accepting an output request for outputting the entity information; generating necessity information indicative of an extent of a necessity for outputting the entity information based on a history of the output request for outputting the entity information; and outputting the reference information including the information for specifying the entity information or the entity information when accepting a request for outputting information relating to the entity information. The outputting step i) outputs the reference information including the information for specifying the entity information when the necessity information for the entity information does not satisfy a predetermined condition and ii) outputs the entity information when the necessity information for the entity information satisfies the condition.

### BRIEF DESCRIPTION OF THE DRAWINGS

Exemplary embodiment of the present invention will be described in detail based on the following figures, wherein:

FIG. 1 is a diagram showing an example of a network structure of an information processing system according to an embodiment of the invention;

FIG. 2 is a diagram showing an example of a hardware structure of an information processing apparatus according to the embodiment of the invention;

FIG. 3A is a functional block diagram showing an example of a function implemented by the information processing apparatus according to the embodiment of the invention;

FIG. 3B is a functional block diagram showing an example of the function implemented by the information processing apparatus according to the embodiment of the invention;

FIG. 3C is a functional block diagram showing an example of the function implemented by the information processing apparatus according to the embodiment of the invention;

FIG. 4 is a diagram showing an example of a data structure of place information;

FIG. 5 is a diagram showing an example of a data structure of message information;

FIG. 6 is a diagram showing an example of a data structure of download information;

FIG. 7 is a diagram showing an example of a Web message list screen;

FIG. 8 is a diagram showing an example of a Web message display screen;

FIG. 9 is a diagram showing an example of a mail message display screen;

FIG. 10 is a diagram showing an example of a data structure of folder and electronic bulletin board corresponding information;

FIG. 11 is a diagram showing an example of a data structure of mail and electronic bulletin board corresponding information;

FIG. 12 is a diagram showing an example of a summary of a processing related to an electronic bulletin board information converting portion;

FIG. 13 is a diagram showing an example of a summary of a processing related to an attribute information managing portion;

FIG. 14 is a diagram showing an example of the mail message display screen; and

FIG. 15 is a flowchart showing an example of a flow of a processing to be carried out by the information processing system according to the embodiment.

### DETAILED DESCRIPTION

An embodiment according to the invention will be described below in detail with reference to the drawings.

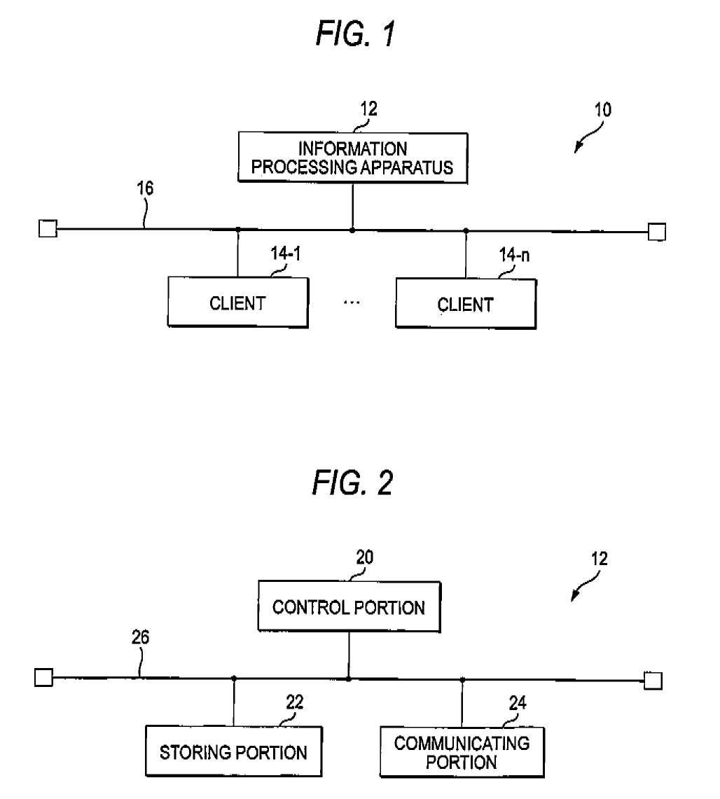

As illustrated in a diagram showing a network structure of FIG. 1, an information processing system 10 according to the embodiment is constituted to include an information processing apparatus 12 and a plurality of user terminals (clients) 14 (14-1 to 14-n). The information processing apparatus 12 and the clients 14 are connected to a network 16 such as a local area network (LAN), and the information processing apparatus 12 and the clients 14 communicate with each other.

The client 14 illustrated in FIG. 1 is constituted by a well-known personal computer including a control device such as a CPU, a storing device such as a hard disk, an output device such as a display, an input device such as a keyboard or a mouse and a communicating device such as a network board. Moreover, a well-known Web browser and a well-known mail client program are installed in the client 14.

FIG. 2 is a diagram illustrating a hardware structure of the information processing apparatus 12 according to the embodiment.

The information processing apparatus 12 is constituted to include a control portion 20, a storing portion 22 and a communicating portion 24. The control portion 20, the storing portion 22 and the communication portion 24 are connected to each other through a bus 26.

The control portion 20 is a program control device such as a CPU and is operated in accordance with a program installed in the information processing apparatus 12. In the embodiment, a program to be a Web application is installed in the information processing apparatus 12.

A Web server program is also installed in the information processing apparatus 12. By starting the Web browser in the client 14 and giving access to the Web server program therefrom, therefore, various screens are displayed through the Web browser on an output device such as a display provided in the client 14.

The storing portion 22 is a storing device such as an RAM or a hard disk, for example. A program to be executed by the control portion 20 is stored in the storing portion 22. Moreover, the storing portion 22 is also operated as a working memory of the control portion 20.

The communicating portion 24 is a network interface card (NIC) for example, and transmits information to the client 14 through the network 16 in accordance with an instruction input from the control portion 20. Moreover, the communicating portion 24 outputs the information received through the network 16 to the control portion 20.

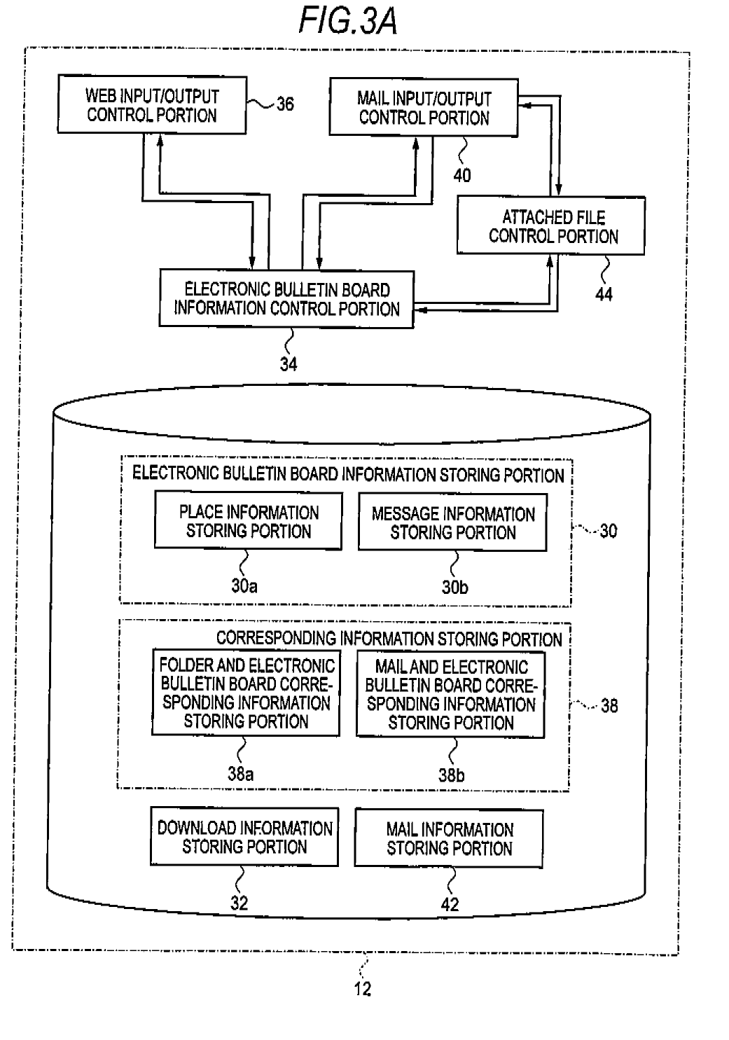

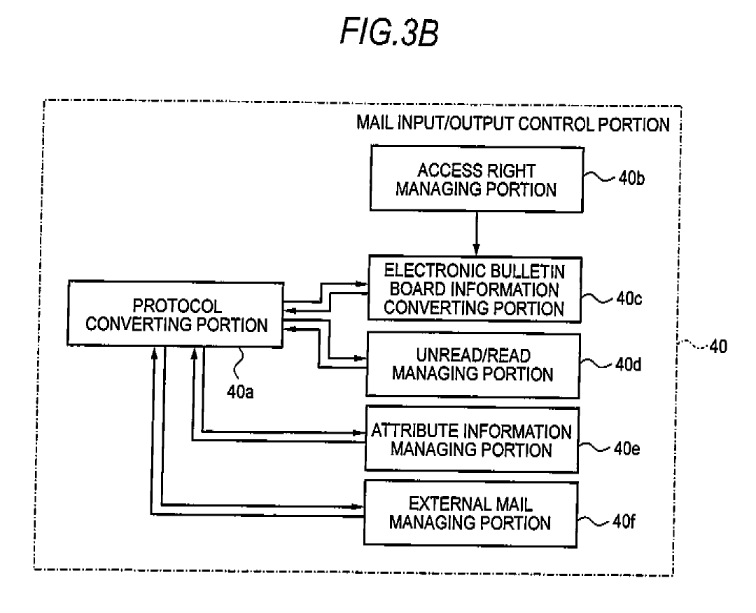

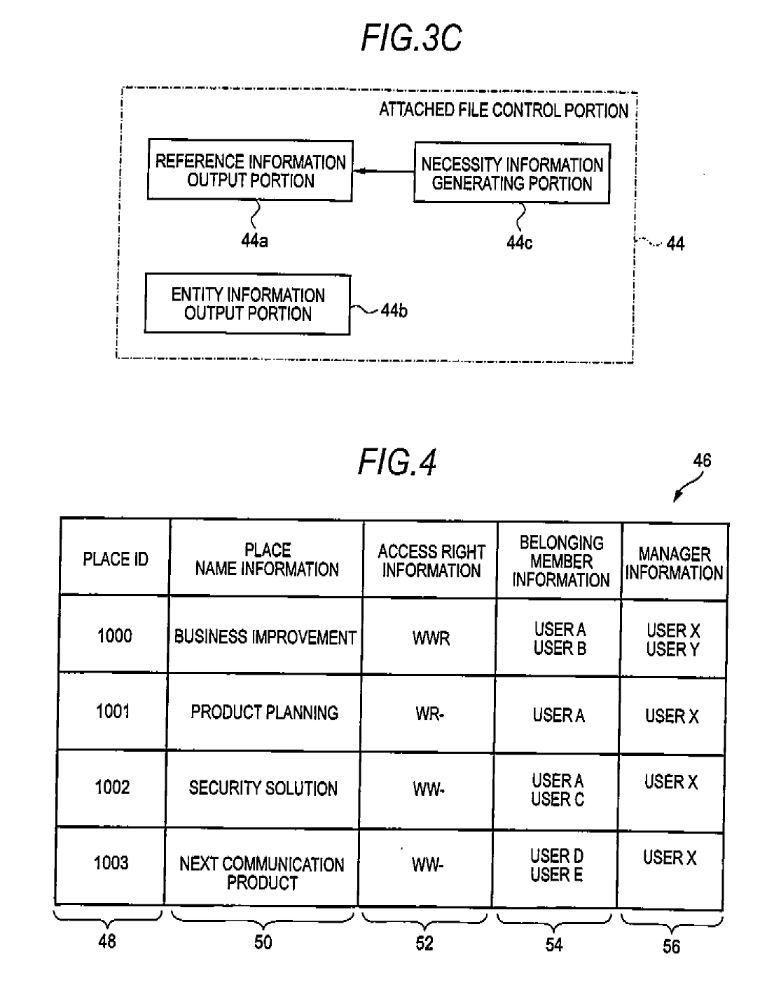

FIGS. 3A, 3B and 3C are functional block diagrams showing an example of a function implemented by the information processing apparatus 12 according to the embodiment.

As illustrated in FIG. 3A, the information processing apparatus 12 according to the embodiment functions to include an electronic bulletin board information storing portion 30, a download information storing portion 32, an electronic bulletin board information control portion 34, a Web input/output control portion 36, a corresponding information storing portion 38, a mail input/output control portion 40, a mail information storing portion 42 and an attached file control portion 44. The electronic bulletin board information storing portion 30, the download information storing portion 32, the corresponding information storing portion 38 and the mail information storing portion 42 are mainly implemented by the storing portion 22. Moreover, the electronic bulletin board information control portion 34, the Web input/output control portion 36, the mail input/output control portion 40 and the attached file control portion 44 are mainly implemented by the control portion 20. The elements are implemented by executing, through the control portion 20, a program installed in the information processing apparatus 12 to be a computer. The program is supplied to the information processing apparatus 12 through a computer readable information transmitting medium such as a CD-ROM or a DVD-ROM or a communication network such as Internet.

As illustrated in FIG. 3A, the electronic bulletin board information storing portion 30 includes a place information storing portion 30a and a message information storing portion 30b. Moreover, the corresponding information storing portion 38 includes a folder and electronic bulletin board corresponding information storing portion 38a and a mail and electronic bulletin board corresponding information storing portion 38b. As illustrated in FIG. 3B, the mail input/output control portion 40 includes a protocol converting portion 40a, an access right managing portion 40b, an electronic bulletin board information converting portion 40c, an unread/read managing portion 40d, an attribute information managing portion 40e, and an external mail managing portion 40f. As illustrated in FIG. 3C, the attached file control portion 44 includes a reference information output portion 44a, an entity information output portion 44b and a necessity information generating portion 44c.

The place information storing portion 30a stores place information 46 illustrated in FIG. 4. As illustrated in FIG. 4, the place information 46 includes a place ID 48 to be an identifier of a place which is a managing unit of information to be managed in the electronic bulletin board (for example, a communication place), place name information 50 indicative of a name of a place, access right information 52 indicative of an access right for a place, belonging member information 54 indicative of a user ID (a user identifier) of a member belonging to a place, and manager information 56 indicative of a user ID of a member to be a place manager. The access right information 52 illustrated in FIG. 4 indicates an access right of each of the place manager, the member belonging to the place and the other members in a character string having three characters in order from left. In the example of FIG. 4, an access right indicative of a read/write authority is represented by “W”, an access right indicative of a read authority is represented by “R”, and an access right indicative of no authority is represented by “-”.

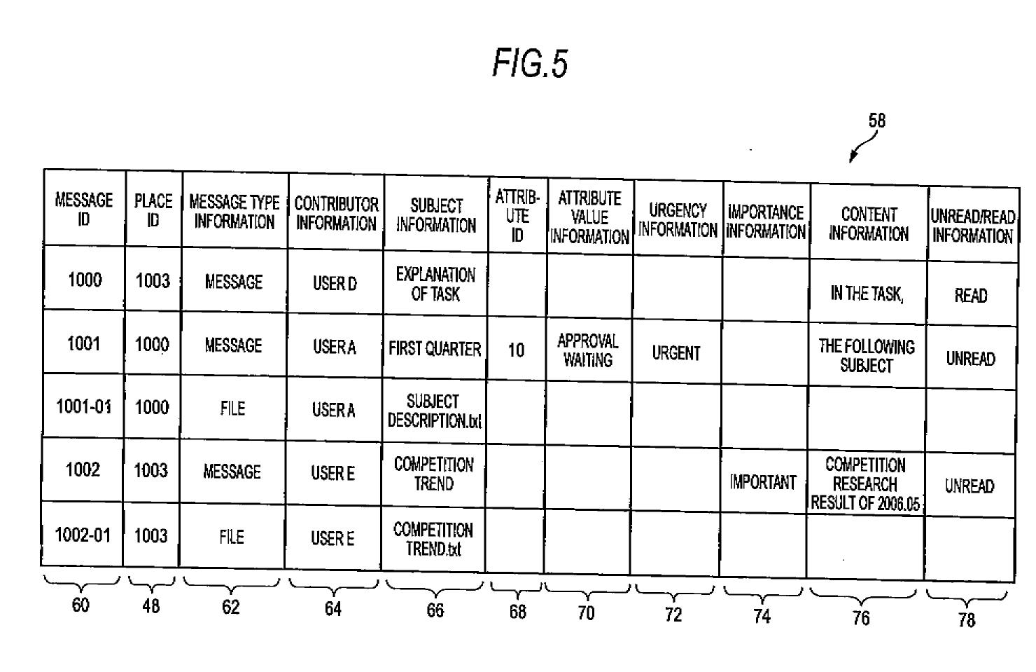

The message information storing portion 30b stores message information 58 illustrated in FIG. 5. In the embodiment, the message information 58 indicates a message displayed on the electronic bulletin board and a file related to the message (for example, an attached file), for example. The message information 58 includes a message ID 60 to be a message identifier, the place ID 48 indicative of an identifier of a place to which a message belongs, message type information 62 indicative of a type of a message, contributor information 64 indicative of a user ID of a contributor of the message information 58, subject information 66 indicative of a subject corresponding to the message information 58, an attribute ID 68 to be an identifier of an attribute corresponding to the message information 58 (for example, an attribute indicative of an approving state), attribute value information 70 indicative of an attribute value of an attribute corresponding to the attribute ID 68, urgency information 72 indicative of an urgency corresponding to the message information 58, importance information 74 indicative of an importance corresponding to the message information 58, content information 76 indicative of a content of the message information 58, and unread/read information 78 indicating whether a message has not been read or has been read. An access right for a place corresponding to the place ID 48 included in the message information 58 may be applied to an access right for the message information 58, for example.

In the embodiment, the message type information 62 indicates that a type of the message information 58 is “message” or “file”, for example. The message information 58 including the message type information 62 having a value of “message” corresponds to a message displayed on the electronic bulletin board. The message information 58 including the message type information 62 having a value of “file” corresponds to an attached file displayed in relation to the message displayed on the electronic bulletin board. In the embodiment, for example, the message ID 60 having a branch number given to the message ID 60 included in the message information 58 corresponding to the message related to the attached file is assigned to the message ID 60 included in the message information 58 corresponding to the attached file. In the embodiment, thus, the message information 58 corresponding to a message is related to the message information 58 corresponding to the attached file associated with the message.

In the case in which the value of the message type information 62 is “file”, the subject information 66 corresponds to a file name of the attached file, for example. In the case in which the value of the message type information 62 is “file”, the content information 76 corresponds to a content of the file (for example, the attached file), for example.

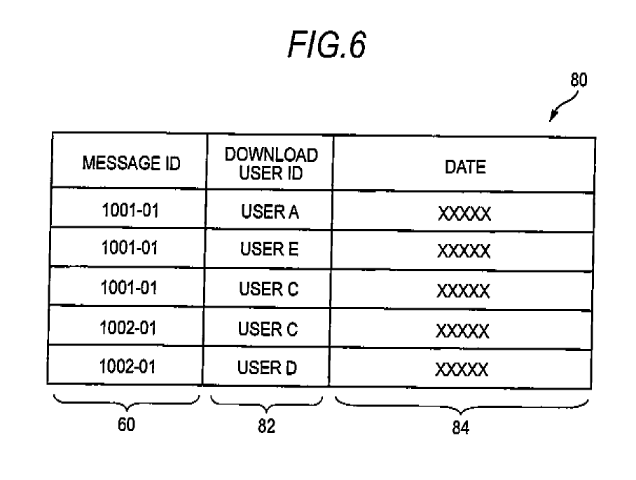

The download information storing portion 32 stores download information 80 illustrated in FIG. 6. The download information 80 includes the message ID 60, a download user ID 82 and date information 84. The message ID 60 indicates the message ID 60 corresponding to a file to which a download request is given (for example, the attached file). The download user ID 82 indicates a user ID of a user giving the download request. The date information 84 indicates a date that the download request is given.

The electronic bulletin board information control portion 34 carries out a control for the place information 46 stored in the place information storing portion 30a or the message information 58 stored in the message information storing portion 30b. More specifically, the electronic bulletin board information control portion 34 accepts an instruction from the Web input/output control portion 36 or the mail input/output control portion 40, for example. The electronic bulletin board information control portion 34 acquires the place information 46 stored in the place information storing portion 30a and the message information 58 stored in the message information storing portion 30b. The electronic bulletin board information control portion 34 carries out an output to the Web input/output control portion 36 or the mail input/output control portion 40.

The Web input/output control portion 36 reshapes the message information 58 for a Web browser display and outputs the reshaped information. Moreover, the Web input/output control portion 36 accepts information transmitted from the client 14 through the Web browser. Then, the Web input/output control portion 36 outputs, to the electronic bulletin board information control portion 34, information indicative of an instruction based on the accepted information.

In the embodiment, for example, when the client 14 transmits the place information 46 or the message information 58 to the information processing apparatus 12, the Web input/output control portion 36 of the information processing apparatus 12 accepts the information. Then, the Web input/output control portion 36 outputs the place information 46 or the message information 58 to the electronic bulletin board information control portion 34. Thereafter, the electronic bulletin board information control portion 34 outputs the accepted place information 46 to the place information storing portion 30a. Moreover, the electronic bulletin board information control portion 34 outputs the accepted message information 58 to the message information storing portion 30b.

When the client 14 transmits an output request for a Web place list screen (not shown) to the information processing apparatus 12 in relation to the user ID, for example, the Web input/output control portion 36 of the information processing apparatus 12 accepts the output request. Then, the Web input/output control portion 36 outputs, to the electronic bulletin board information control portion 34, a request for acquiring the message information 58 including the accepted user ID. Thereafter, the electronic bulletin board information control portion 34 determines the place information 46 to be a basis of the Web place list screen to be output based on the accepted user ID and the access right information 52 included in the place information 46. Subsequently, the electronic bulletin board information control portion 34 acquires the place information 46 from the place information storing portion 30a and outputs the place information 46 to the Web input/output control portion 36. Next, the Web input/output control portion 36 accepts the place information 46 and generates the Web place list screen, and outputs the Web place list screen to an output device such as the display provided in the client 14.

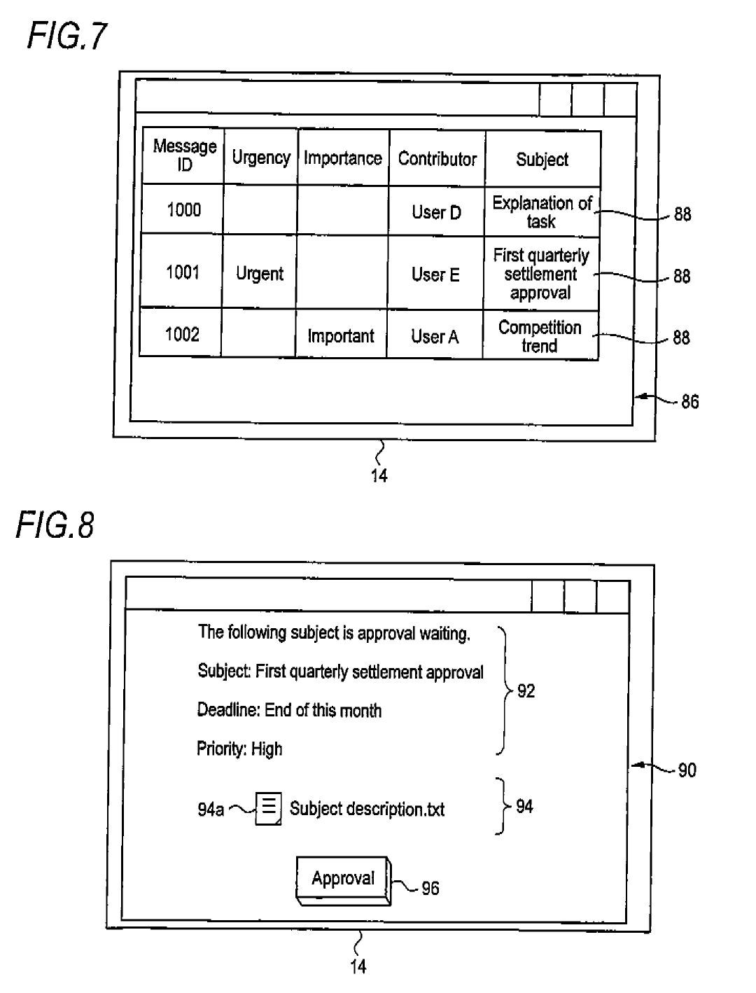

When the client 14 transmits a request for outputting, to the information processing apparatus 12, a Web message list screen 86 illustrated in FIG. 7 in relation to the place ID 48, for example, the Web input/output control portion 36 of the information processing apparatus 12 accepts the output request. Thereafter, the Web input/output control portion 36 outputs, to the electronic bulletin board information control portion 34, a request for acquiring the message information 58 included in the accepted place ID 48. Subsequently, the electronic bulletin board information control portion 34 acquires the message information 58 included in the accepted place ID 48 from the message information storing portion 30b and outputs the message information 58 to the Web input/output control portion 36. Next, the Web input/output control portion 36 generates the Web message list screen 86 illustrated in FIG. 7 based on the accepted message information 58 and outputs the Web message list screen 86 to the output device such as the display provided in the client 14. In the embodiment, the Web input/output control portion 36 holds the accepted message information 58.

As illustrated in FIG. 7, the Web message list screen 86 includes a message link 88, for example. The corresponding message ID 60 is related to the message link 88. When the user clicks the message link 88 by using a mouse, the client 14 transmits a request for outputting a Web message display screen 90 illustrated in FIG. 8 to the information processing apparatus 12 in relation to the message ID 60 associated with the message link 88, for example. Then, the Web input/output control portion 36 of the information processing apparatus 12 accepts the output request. Thereafter, the Web input/output control portion 36 generates the Web message display screen 90 illustrated in FIG. 8 based on the message information 58 corresponding to the message ID 60 and the message information 58 indicative of a file (an attached file) related to the message information 58 and outputs the Web message display screen 90 to the output device such as the display provided in the client 14.

The Web message display screen 90 illustrated in FIG. 8 includes a message display portion 92, an attached file display portion 94 and an approval button 96, for example. A message indicated by the content information 76 included in the message information 58 is displayed on the message display portion 92. An attached file icon 94a indicative of an attached file related to the message displayed on the message display portion 92 is displayed on the attached file display portion 94. The message ID 60 corresponding to the attached file is related to the attached file icon 94a.

When the user clicks the approval button 96 by using the mouse, the client 14 transmits a request for approving the message information 58 to the information processing apparatus 12 in relation to the corresponding message ID 60, for example. Then, the Web input/output control portion 36 of the information processing apparatus 12 accepts the approval request and outputs a request for updating the message information 58 to the electronic bulletin board information control portion 34. Thereafter, the electronic bulletin board information control portion 34 accepts the update request and updates a value of the attribute value information 70 included in the message information 58 containing the message ID 60 into “approved”.

When the Web message display screen 90 illustrated in FIG. 8 is displayed and the user clicks the attached file icon 94a displayed on the message display portion 92 by using the mouse, the client 14 transmits a request for downloading the attached file to the information processing apparatus 12 in relation to the message ID 60 corresponding to the attached file, for example. Then, the Web input/output control portion 36 of the information processing apparatus 12 accepts the download request and transmits, to the client 14, the attached file corresponding to the content information 76 included in the message information 58 based on the message information 58 corresponding to the message ID 60. Thereafter, the client 14 receives the attached file. Subsequently, the Web input/output control portion 36 outputs a request for updating the download information 80 to the electronic bulletin board information control portion 34. The electronic bulletin board information control portion 34 accepts the updating request and updates the download information 80. More specifically, for example, the electronic bulletin board information control portion 34 generates the download information 80 including the message ID 60 corresponding to the attached file which is downloaded, the download user ID 82 corresponding to a user giving the download request, and the date information 84 indicative of a date that the download request is given, and outputs the download information 80 to the download information storing portion 32.

As described above, in the embodiment, the content indicated by the place information 46 or the message information 58 is output through the Web browser to the output device such as the display provided in the client 14, for example.

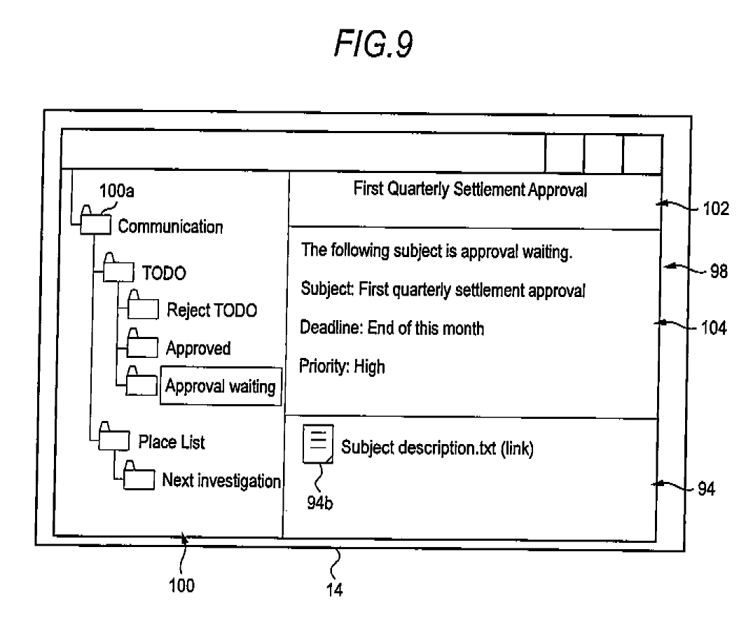

In the embodiment, for example, the content indicated by the place information 46 or the message information 58 is also output to the output device such as the display provided in the client 14 through a mail client program as illustrated in FIG. 9. FIG. 9 is a diagram showing an example of a mail message display screen 98 which is displayed on the output device such as the display provided in the client 14 through the mail client program. The mail client program installed in the client 14 generates the mail message display screen 98 illustrated in FIG. 9 based on the information received from the information processing apparatus 12 and outputs the mail message display screen 98 to the output device such as the display provided in the client 14.

The mail message display screen 98 includes a folder icon display portion 100, a subject display portion 102, a mail display portion 104 and the attached file display portion 94, for example. A folder icon 100a is hierarchically displayed on the folder icon display portion 100. A folder indicated by the folder icon 100a corresponds to a place represented by the place information 46, for example. In the embodiment, when novel place information 46 is stored in the place information storing portion 30a, for example, the folder icon 100a corresponding to the novel place information 46 is displayed on the folder icon display portion 100. A name of a place indicated by the place name information 50 is displayed on a right side of the folder icon 100a. A subject indicated by the subject information 66 included in the message information 58 belonging to a place corresponding to the folder indicated by the folder icon 100a is displayed in a list on the subject display portion 102, for example. A message indicated by the content information 76 included in the message information 58 corresponding to any of the subjects displayed on the subject display portion 102 which is selected by the user is displayed as a text of an electronic mail on the mail display portion 104, for example. A link file icon 94b corresponding to a link file to be a link to an attached file related to a message displayed on the message display portion 92 is displayed on the attached file display portion 94, for example.

As described above, the corresponding information storing portion 38 includes the folder and electronic bulletin board corresponding information storing portion 38a and the mail and electronic bulletin board corresponding information storing portion 38b (see FIG. 3A).

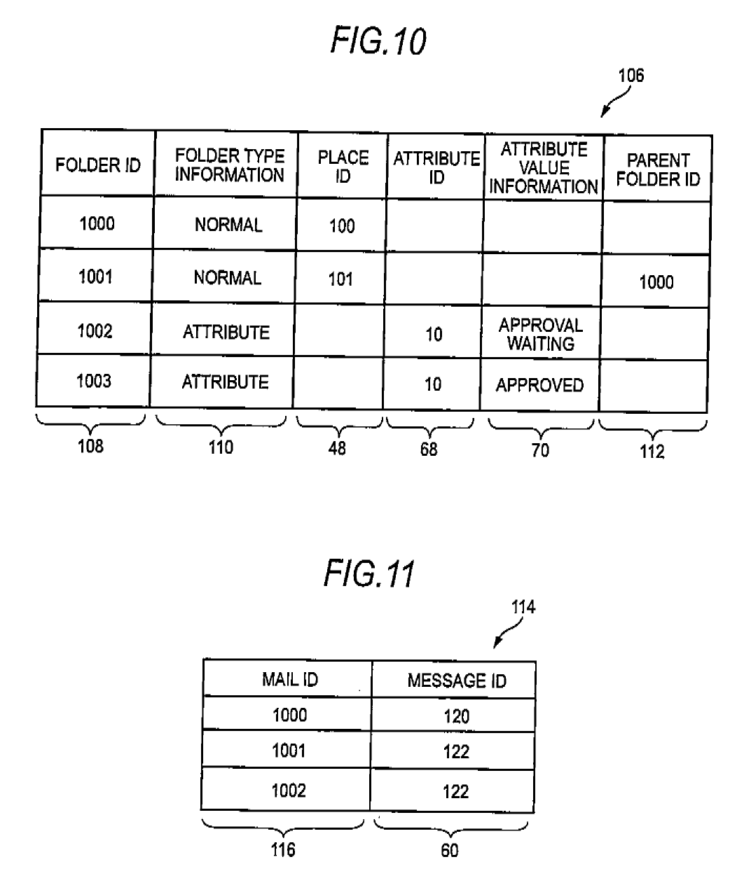

The folder and electronic bulletin board corresponding information storing portion 38a stores folder and electronic bulletin board corresponding information 106 illustrated in FIG. 10. The folder and electronic bulletin board corresponding information 106 indicates a correspondence of the place information 46 to a folder indicated by the folder icon 100a displayed on the mail message display screen 98. As illustrated in FIG. 10, the folder and electronic bulletin board corresponding information 106 includes a folder ID 108, folder type information 110, the place ID 48, the attribute ID 68, the attribute value information 70 and a parent folder ID 112. The folder ID 108 is an identifier of the folder indicated by the folder icon 100a. The folder type information 110 indicates a type of the folder indicated by the folder icon 100a and represents a value of “normal” (a folder corresponding to the folder and electronic bulletin board corresponding information 106 will be hereinafter referred to as a normal folder) or “attribute” (a folder corresponding to the folder and electronic bulletin board corresponding information 106 will be hereinafter referred to as an attribute folder) in the embodiment, for example.

A value of the place ID 48 to be the identifier of the place information 46 corresponding to the folder is set to the folder and electronic bulletin board corresponding information 106 corresponding to the normal folder, for example. A value of the attribute ID 68 to be the identifier of the attribute corresponding to the folder is set to the folder and electronic bulletin board corresponding information 106 corresponding to the attribute folder, for example, and an attribute value of an attribute corresponding to the attribute ID 68 is set to the attribute value information 70.

The parent folder ID 112 indicates the folder ID 108 of a folder displayed as a parent folder on the folder icon display portion 100 illustrated in FIG. 9.

The mail and electronic bulletin board corresponding information storing portion 38b stores mail and electronic bulletin board corresponding information 114 illustrated in FIG. 11. The mail and electronic bulletin board corresponding information 114 includes a mail ID 116 and the message ID 60. The mail ID 116 is an identifier of an electronic mail displayed on the mail display portion 104. The message ID 60 indicates the message ID 60 included in the message information 58 containing, as the content information 76, a message corresponding to an electronic mail text displayed on the mail display portion 104. The message ID 60 may be related to a plurality of mail IDs 116 which is different from each other.

In the embodiment, the mail input/output control portion 40 converts the place information 46 or the message information 58 accepted from the electronic bulletin board information control portion 34 into information indicative of a folder or an electronic mail and outputs the information, for example. In the embodiment, moreover, the mail input/output control portion 40 accepts an interfolder moving operation for an electronic mail and outputs an instruction for updating the message information 58 to the electronic bulletin board information control portion 34, for example.

In the embodiment, the mail input/output control portion 40 includes the protocol converting portion 40a, the access right managing portion 40b, the electronic bulletin board information converting portion 40c, the unread/read managing portion 40d, the attribute information managing portion 40e and the external mail managing portion 40f as described above (see FIG. 3B).

The protocol converting portion 40a converts a data format conforming to a communication protocol for a mail client program, for example, SMTP (Simple Mail Transfer Protocol) or IMAP (Internet Message Access Protocol) and a data format used by the information processing apparatus 12, for example.

The access right managing portion 40b generates information indicative of a folder access right based on the access right information 52 included in the place information 46, and outputs the information to the electronic bulletin board information converting portion 40c.

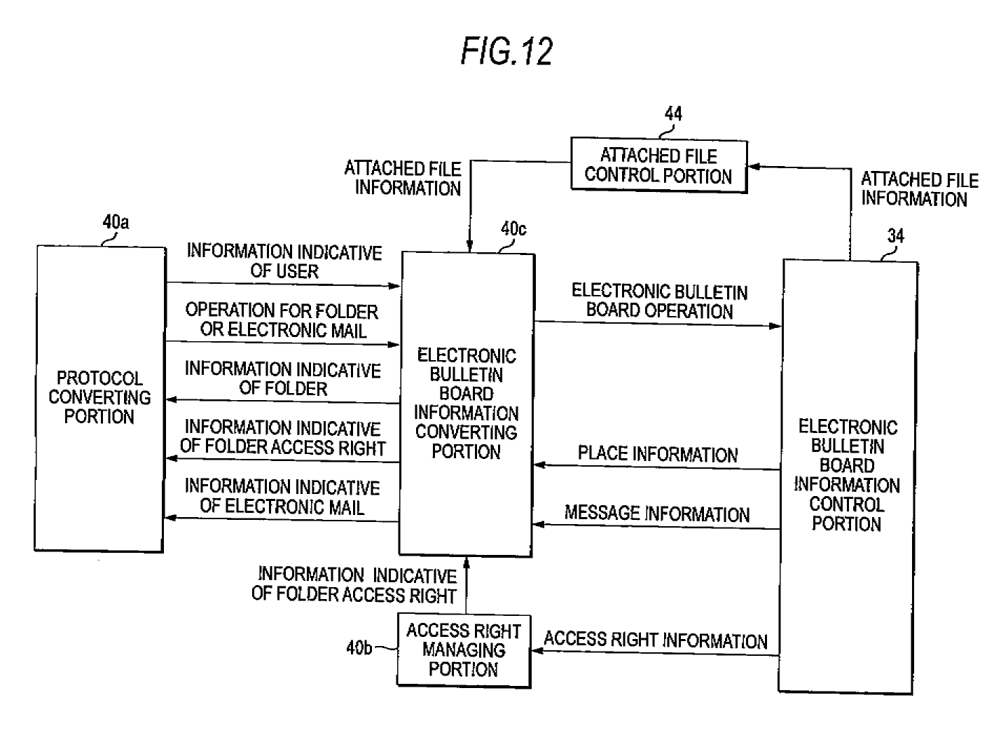

FIG. 12 shows an example of a summary of a processing related to the electronic bulletin board information converting portion 40c. The electronic bulletin board information converting portion 40c converts information indicative of an operation such as an interfolder moving and copying operation for the message information 58, a folder creating operation or a folder updating operation which is accepted together with information indicative of a user such as a user ID into information indicative of an operation in the electronic bulletin board, and outputs the information to the electronic bulletin board information control portion 34, for example. Moreover, the electronic bulletin board information converting portion 40c filters the place information 46 or the message information 58 which is accepted from the electronic bulletin board information control portion 34 in accordance with information indicative of a folder access right accepted from the access right managing portion 40b, for example, and converts the information into a folder structure to be displayed on the mail message display screen 98 illustrated in FIG. 9 (information indicative of a folder, information indicative of a folder access right or information indicative of an electronic mail present in the folder) and outputs the folder structure to the protocol converting portion 40a, for example. More specifically, the electronic bulletin board information converting portion 40c converts the message information 58 accepted from the electronic bulletin board information control portion 34 into a folder structure including an electronic mail corresponding to the message information 58 in a folder corresponding to the place ID 48 included in the message information 58 and outputs the folder structure to the protocol converting portion 40a, for example.

In the embodiment, for example, when the electronic bulletin board information converting portion 40c outputs a request for outputting the message information 58 to the electronic bulletin board information control portion 34, the electronic bulletin board information control portion 34 outputs, to the electronic bulletin board information converting portion 40c, the message information 58 in which a value of the message type information 62 is “message”. Then, the message information 58 in which the value of the message type information 62 is “file” indicative of a file related to the message is output to the attached file control portion 44. Thereafter, the attached file control portion 44 replaces the content information 76 included in the message information 58 with a link file corresponding to the file (for example, an attached file) and outputs the link file to the electronic bulletin board information converting portion 40c. An operation of the attached file control portion 44 will be described below in detail.

The unread/read managing portion 40d carries out a conversion between information indicating whether an electronic mail has not been read or has been read and the unread/read information 78 included in the message information 58.

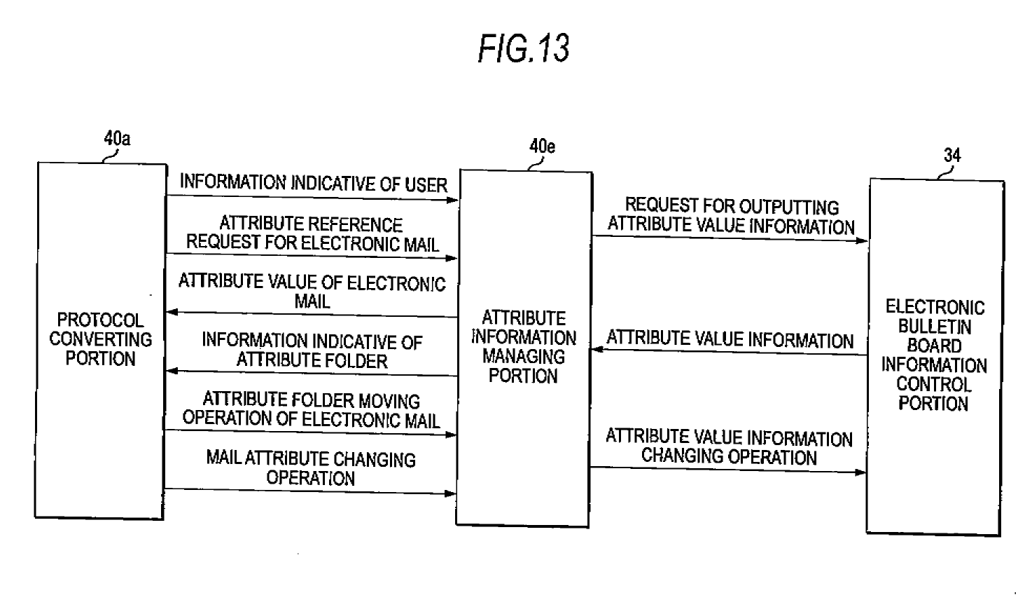

FIG. 13 shows an example of a summary of a processing related to the attribute information managing portion 40e. The attribute information managing portion 40e converts the attribute ID 68 or the attribute value information 70 which is included in the message information 58 into information indicative of a folder in which an electronic mail corresponding to the message information 58 is stored or information indicative of an attribute of the electronic mail corresponding to the message information 5B.

The attribute information managing portion 40e accepts a reference request for an attribute of an electronic mail together with information indicative of a user such as a user ID and converts the reference information into a request for outputting the attribute value information 70 included in the message information 58, and outputs the output request to the electronic bulletin board information control portion 34, for example. Then, the electronic bulletin board information control portion 34 outputs the attribute value information 70 to the attribute information managing portion 40e. Thereafter, the attribute information managing portion 40e outputs an attribute value indicated by the attribute value information 70 to the protocol converting portion 40a.

Moreover, the attribute information managing portion 40e determines an attribute folder to be stored based on a value of the attribute ID 68 and that of the attribute value information 70 which are included in the message information 58 to be output, for example. Then, the attribute information managing portion 40e outputs information indicative of the attribute folder including the message information 58 to the protocol converting portion 40a.

Moreover, the attribute information managing portion 40e converts information indicative of a moving operation of an electronic mail between folders corresponding to the folder and electronic bulletin board corresponding information 106 including the folder type information 110 having a value of “attribute” which is carried out by the user in the mail client program executed by the client 14 or information indicative of an operation for changing the attribute of the electronic mail into information indicative of an instruction for updating the attribute value information 70 included in the message information 58 (for example, an instruction for updating a value indicated by the attribute value information 70 from “approval waiting” to “approved”) and outputs the information thus obtained to the electronic bulletin board information control portion 34, for example. Then, the electronic bulletin board information control portion 34 updates the attribute value information 70 included in the message information 58 in accordance with the instruction.

The external mail managing portion 40f acquires information indicative of an electronic mail from the mail information storing portion 42 to the client 14 via the protocol converting portion 40a. Thus, the mail information storing portion 42 stores the electronic mail.

An operation of the attached file control portion 44 will be described in detail.

As described above, the attached file control portion 44 includes the reference information output portion 44a, the entity information output portion 44b and the necessity information generating portion 44c (see FIG. 3C).

The reference information output portion 44a outputs reference information (in the embodiment, for example, a link file) including information (for example, the message ID 60 corresponding to an attached file) for specifying corresponding entity information (in the embodiment, for example, the attached file). A size (a data size) of the link file may be smaller than that (a data size) of the attached file. In the embodiment, more specifically, referring to the message information 58 which is output from the electronic bulletin board information control portion 34 and in which the value of the message type information 62 is “file” a file (entity information) corresponding to the content information 76 included in the message information 58 is replaced with a link file (reference information) corresponding to the file and the link file is output to the mail input/output control portion 40, for example. In the embodiment, the link file is a URL shortcut file, for example, and corresponds to an external reference corresponding to the attached file. The reference information output portion 44a may replace the attached file with an MIME external-body format, for example, or location information indicative of a location of the attached file (for example, a URL character string) which is to be displayed in a mail text. The mail client program to be executed by the client 14 may generate the mail message display screen 98 displaying the URL character string for the attached file on the mail display portion 104 and may output the mail message display screen 98 to the output device such as the display provided in the client 14.

The entity information output portion 44b outputs the entity information (for example, the attached file) in accordance with the information for specifying the entity information (for example, the message ID 60) when an output request for the entity information (for example, the attached file) is accepted. In the embodiment, for example, when the user clicks the link file icon 94b displayed on the attached file display portion 94 by using the mouse, the client 14 relates, to the user ID, a request for outputting an attached file corresponding to a link file corresponding to the link file icon 94b and transmits the output request to the information processing apparatus 12. Then, the mail input/output control portion 40 accepts the output request and gives an instruction for outputting the attached file to the entity information output portion 44b. Thereafter, the entity information output portion 44b accepts an output request for the entity information. Subsequently, the entity information output portion 44b gives the electronic bulletin board information control portion 34 an instruction for outputting the message information 58 including, as the content information 76, the attached file to be an output target. Next, the electronic bulletin board information control portion 34 outputs, to the entity information output portion 44b, the message information 58 to be the output target. Then, the entity information output portion 44b outputs, to the mail input/output control portion 40, the attached file corresponding to the content information 76 included in the accepted message information 58. Thereafter, the mail input/output control portion 40 transmits the attached file to the client 14.

In the embodiment, for example, the entity information output portion 44b generates the download information 80 including the message ID 60 corresponding to the output file, the download user ID 82 corresponding to a user giving an output request for the entity information (for example, a user indicated by the user ID accepted by the entity information output portion 44b) and the date information 84 indicative of a date that the output request for the entity information is given when the attached file is output, and outputs the download information 80 to the download information storing portion 32.

The necessity information generating portion 44c generates necessity information indicative of an extent of a necessity for outputting the entity information based on a history (an accomplishment) of the output request for the entity information. In the embodiment, the necessity information generating portion 44c generates necessity information indicative of the number of the output requests for the entity information (that is, the number of requests for downloading the respective files) based on the download information 80.

The necessity information generated by the necessity information generating portion 44c is not restricted to necessity information indicative of the number of the download requests. For example, the necessity information generating portion 44c may generate necessity information (that is, necessity information indicative of a reference ratio) indicative of a ratio of the number of users giving the output request for the entity information (for example, the user indicated by the user ID accepted by the entity information output portion 44b) to the number of users having a read authority for the message information 58 including a message related to a file based on the download information 80. Moreover, the necessity information generating portion 44c may generate a flag indicating whether the reference information or the entity information is to be output based on the download information 80, for example. In addition, the necessity information generating portion 44c may generate the necessity information based on an output accomplishment (for example, the number of outputs) of the entity information (for example, the attached file). Thus, the necessity information generating portion 44c may generate the necessity information based on a ratio of the number of the users giving the output request for the entity information to the number of users to whom the entity information is to be offered which is calculated based on the accomplishment of the output request for the entity information.

Moreover, the necessity information generating portion 44c may generate the necessity information based on the importance information 74 or the urgency information 72 which is included in the message information 58. Furthermore, the necessity information generating portion 44c may generate the necessity information indicating whether or not the user indicated by the contributor information 64 included in the message information 58 is a boss of the user giving the request for outputting a message. In addition, the necessity information generating portion 44c may generate a plurality of necessity information based on the information which are different from each other, for example.

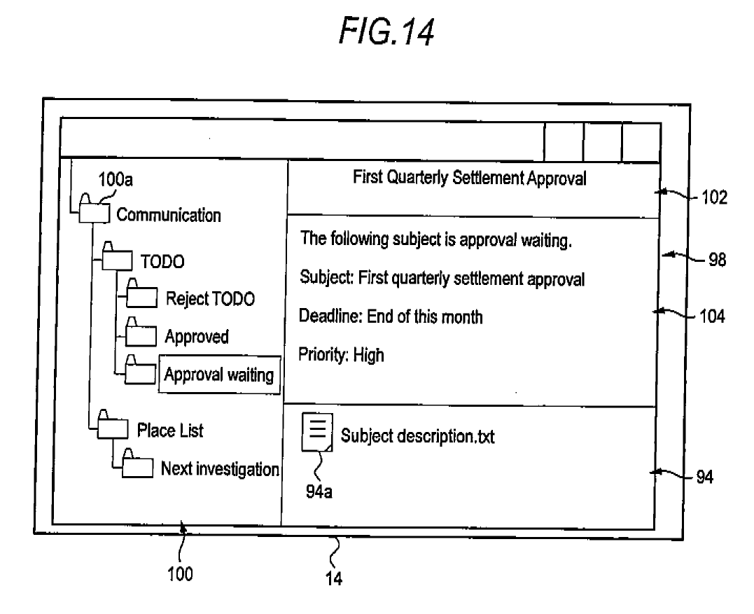

Then, the reference information output portion 44a outputs the entity information (for example, the attached file) in place of the reference information (for example, the link file) when the necessity information (in the embodiment, for example, the number of downloading operations) satisfies a predetermined condition. More specifically, for example, when the reference information output portion 44a does not execute the processing for replacing the link file of the file corresponding to the content information 76 included in the message information 58 when the number of the operations for downloading the attached file corresponding to the link file is equal to or greater than a predetermined number (for example, one). In other words, the reference information output portion 44a outputs the file (the attached file) to the mail input/output control portion 40 in place of the link file. Then, the mail input/output control portion 40 carries out a protocol conversion over the message information 58 included in the attached file and transmits the message information 58 thus converted to the client 14, for example. Thereafter, the mail client program executed by the client 14 receives the message information 58 and generates the mail message display screen 98 in which the attached file icon 94a indicative of the attached file is displayed on the attached file display portion 94 as illustrated in FIG. 14, and outputs the mail message display screen 98 to the output device such as the display provided in the client 14, for example. At this timer the mail client program executed by the client 14 outputs the received message information 58 (including the attached file) to a storing device provided in the client 14, for example. When accepting a request for outputting information about the entity information, thus, the reference information output portion 44a outputs the reference information for specifying the entity information if the necessity information for the entity information does not satisfy a predetermined condition and outputs the entity information if the necessity information for the entity information satisfies the same condition.

When the necessity information for the entity information specified by the reference information (for example, the download information 80) satisfies the predetermined condition after the reference information is output, the entity information specified by the reference information may be output to a request source of the request for outputting the entity information.

When the user clicks the attached file icon 94a, the mail client program outputs the content of the attached file stored in the storing device provided in the client 14 to the output device such as the display provided in the client 14, for example.

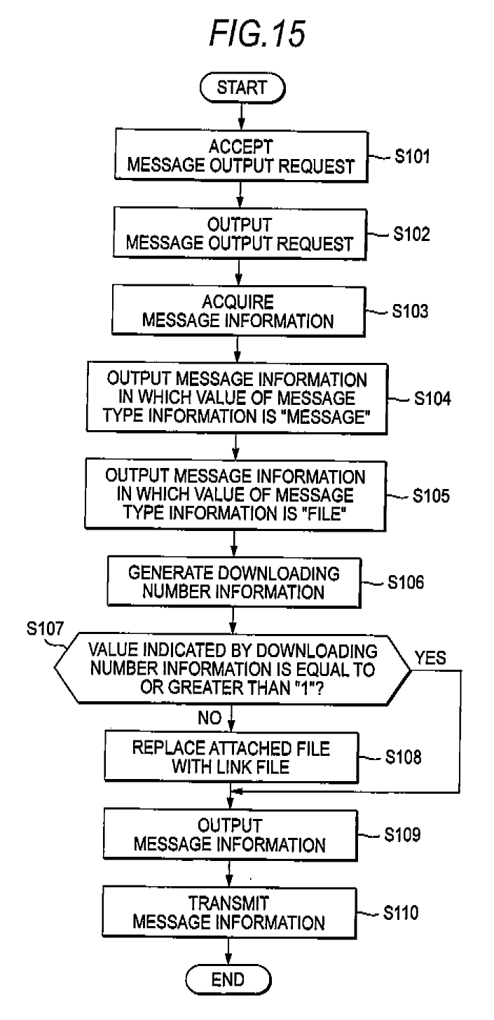

With reference to a flowchart of FIG. 15, next, description will be given to an example of a flow of a processing to be carried out from the acceptance of the message output request output through the mail client program executed over the client 14 by the information processing apparatus 12 to the transmission of the message information 58 to the client 14 in the information processing system 10 according to the embodiment.

First of all, the mail input/output control portion 40 accepts the message output request (S101). Then, the electronic bulletin board information control portion 34 converts a data format of the message output request into a data format to be used by the information processing apparatus 12 and outputs the data format thus obtained to the electronic bulletin board information control portion 34 (S102). Thereafter, the electronic bulletin board information control portion 34 acquires, from the message information storing portion 30b, the message information 58 to be output (S103). Subsequently, the electronic bulletin board information control portion 34 outputs, to the mail input/output control portion 40, the message information 58 which is acquired in the processing illustrated in the S103 and in which the value of the message type information 62 is “message”, and the mail input/output control portion 40 accepts the message information 58 (S104). Next, the electronic bulletin board information control portion 34 outputs, to the attached file control portion 44, the message information 58 which is acquired in the processing illustrated in the S103 and in which the value of the message type information 62 is “file”, and the attached file control portion 44 accepts the message information 58 (S105).

Then, the attached file control portion 44 generates downloading number information indicative of the number of the operations for downloading the file corresponding to the accepted message information 58 based on the download information 80 (S106). Thereafter, it is ascertained whether or not a value indicated by the downloading number information is equal to or greater than “1” (S107). If the value indicated by the downloading number information is smaller than “1” (that is, zero) (S107: N), the attached file control portion 44 replaces the file (for example, the attached file) indicated by the content information 76 included in the message information 58 with the link file corresponding to the file (S108). If the value indicated by the downloading number information is equal to or greater than “1” (S107: Y), the attached file control portion 44 does not execute the replacement.

Subsequently, the attached file control portion 44 outputs the message information 58 to the mail input/output control portion 40, and the mail input/output control portion 40 accepts the message information 58 (S109). Then, the mail input/output control portion 40 carries out a protocol conversion, and furthermore, transmits the message information 58 to the client 14 (S110).

The invention is not restricted to the embodiment.

For example, the information processing apparatus 12 may be a mail server. The message information 58 may be an electronic mail. More specifically, for example, the control portion 20 may accept an electronic mail including an attached file setting a plurality of users to be transmitting destinations from an information managing system (not shown) for managing the attached file, and may generate the message information 58 corresponding to a text of the electronic mail and the message information 58 corresponding to the attached file and may output them to the storing portion 22. The information managing system may manage the text of the electronic mail. When accepting a request for outputting the electronic mail from the user to be the transmitting destination, for example, the control portion 20 may replace the attached file with a link file and may transmit, to the client 14, an electronic mail to which the link file corresponding to the attached file is attached. For example, the control portion 20 may accept a request for outputting the attached file from the client 14 and may transmit the corresponding attached file to the client 14, and furthermore, may generate the download information 80 including the message ID 60 contained in the message information 58 corresponding to the attached file, the download user ID 82 corresponding to the user giving the download request and the date information 84 indicative of a download request date and may output the download information 80 to the storing portion 22. When accepting a request for outputting an electronic mail from another user to be a transmitting destination, for example, the control portion 20 may decide that the download request for the attached file was given based on the download information 80 and may transmit an electronic mail having the attached file to the client 14 without replacing the attached file with the link file. At this time, in the case in which a ratio of the number of the users giving the download request to the number of the users to be the transmitting destinations of the electronic mail (that is, users to whom the electronic mail is to be transmitted) is equal to or greater than a predetermined value based on the download information 80, the control portion 20 may transmit the electronic mail having the attached file to the client 14 without replacing the attached file with the link file.

When a predetermined condition is satisfied after the information processing apparatus 12 to be the mail server transmits, to the client 14, the electronic mail to which the link file corresponding to the attached file is attached (for example, when the ratio of the number of the users giving the download request to the number of the users to be the transmitting destinations of the electronic mail is equal to or greater than a predetermined value), it is also possible to transmit the attached file corresponding to the link file to the client 14 to which the link file has already been transmitted.

Moreover, information indicative of a whole electronic mail text may correspond to the entity information and information indicative of a beginning part of the electronic mail may correspond to the reference information, for example. More specifically, when accepting a request for outputting the electronic mail from the user to be the transmitting destination, the control portion 20 may delete parts in the whole mail text other than the beginning part, and furthermore, may transmit the electronic mail to the client 14. Then, the control portion 20 may accept a request for outputting the whole electronic mail text from the client 14 and may transmit the corresponding whole electronic mail to the client 14, and furthermore, may generate the download information 80 including the message ID 60 contained in the message information 58 corresponding to the electronic mail, the download user ID 82 corresponding to the user giving the output request, and the date information 84 indicative of the download request date and may output the download information 80 to the storing portion 22, for example. When accepting the request for outputting the electronic mail from the user to be the transmitting destination of the electronic mail again, for example, the control portion 20 may decide that the request for outputting the whole electronic mail text was given and may transmit the whole mail text to the client 14.

The information processing apparatus 12 may be an instant messenger server.

Although the data structures of various information are represented by table formats in the embodiment, moreover, the representation is only illustrative and it is a matter of course that other data structures may be used for mounting.

Furthermore, the information processing apparatus 12 may be constituted by a single housing or a plurality of housings.

The specific numeric values and character strings described in the specification are illustrative and the invention is not restricted thereto.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing method for acquiring entity information or reference information including information for specifying the entity information, the method comprising:
outputting the entity information when accepting an output request for outputting the entity information;
generating necessity information indicative of an extent of a necessity for outputting the entity information based on a history of the output request for outputting the entity information; and
outputting the reference information including the information for specifying the entity information or the entity information when accepting a request for outputting information relating to the entity information,
wherein
the outputting step i) outputs the reference information including the information for specifying the entity information when the necessity information for the entity information does not satisfy a predetermined condition and ii) outputs the entity information when the necessity information for the entity information satisfies the condition.

2. The information processing method according to claim 1,
wherein
the generating step generates the necessity information based on the number of the output requests for outputting the entity information.

3. The information processing method according to claim 1,
wherein
the generating step generates the necessity information based on a ratio of the number of users issuing the output request for outputting the entity information to the number of users to whom the entity information is to be provided.

4. The information processing method according to claim 1,
wherein
a size of the reference information is smaller than that of the entity information.

5. An electronic mail processing method for processing an electronic mail stored in a computer, including body information and attached information, the process comprising:
transmitting the attached information when accepting an acquiring request for acquiring the attached information;
generating necessity information indicative of an extent of a necessity for transmitting the attached information based on a history of the acquiring request for acquiring the attached information; and
transmitting the body information in the electronic mail when accepting a request for acquiring the electronic mail,
wherein
the transmitting step transmits i) the body information and reference information for specifying the attached information associated with each other when the necessity information for the attached information does not satisfy a predetermined condition, and ii) transmits the body information and the attached information associated with each other when the necessity information for the attached information satisfies the condition.

6. The electronic mail processing method according to claim 5,
wherein
the electronic mail stored in the computer is transmitted from an information managing system that sets the attached information as managing target information.

7. A computer readable medium storing a program causing a computer to execute a process for acquiring entity information or reference information including information for specifying the entity information, the process comprising;
outputting the entity information when accepting an output request for outputting the entity information;
generating necessity information indicative of an extent of a necessity for outputting the entity information based on a history of the output request for outputting the entity information; and
outputting the reference information including the information for specifying the entity information or the entity information when accepting a request for outputting information relating to the entity information,
wherein
the outputting step i) outputs the reference information including the information for specifying the entity information when the necessity information for the entity information does not satisfy a predetermined condition and ii) outputs the entity information when the necessity information for the entity information satisfies the condition.

8. The computer readable medium according to claim 7,
wherein
the generating step generates the necessity information based on the number of the output requests for outputting the entity information.

9. The computer readable medium according to claim 7,
wherein
the generating step generates the necessity information based on a ratio of the number of users issuing the output request for the entity information to the number of users to whom the entity information is to be provided.

10. The computer readable medium according to claim 7,
wherein
a size of the reference information is smaller than that of the entity information.

11. A computer readable medium storing a program causing a computer to execute a process for processing an electronic mail stored in a computer, including body information and attached information, the process comprising:
transmitting the attached information when accepting an acquiring request for acquiring the attached information;
generating necessity information indicative of an extent of a necessity for transmitting the attached information based on a history of the acquiring request for acquiring the attached information; and
transmitting the body information in the electronic mail when accepting a request for acquiring the electronic mail,
wherein
the transmitting step i) transmits the body information and reference information for specifying the attached information associated with each other when the necessity information for the attached information does not satisfy a predetermined condition, and ii) transmits the body information and the attached information associated with each other when the necessity information for the attached information satisfies the condition.

12. The computer readable medium according to claim 11,
wherein
the electronic mail stored in the computer is transmitted from an information managing system that sets the attached information as managing target information.

13. An information processing apparatus comprising:
a first output unit that outputs entity information when accepting an output request for outputting the entity information;
a necessity information generating unit that generates necessity information indicative of an extent of a necessity for outputting the entity information based on a history of the output request for outputting the entity information; and
a second output unit that outputs reference information including information for specifying the entity information or the entity information when accepting a request for outputting information relating to the entity information,
wherein the second output unit i) outputs the reference information including the information for specifying the entity information when the necessity information for the entity information does not satisfy a predetermined condition and ii) outputs the entity information when the necessity information for the entity information satisfies the condition.

14. An electronic mail processing apparatus comprising:
an electronic mail storage that stores an electronic mail including body information and attached information;
a first transmitting unit that transmits the attached information when accepting an acquiring request for acquiring the attached information;
a necessity information generating unit that generates necessity information indicative of an extent of a necessity for transmitting the attached information based on a history of the acquiring request for acquiring the attached information; and
a second transmitting unit that transmits the body information in the electronic mail when accepting a request for acquiring the electronic mail
wherein the second transmitting unit i) transmits the body information and reference information for specifying the attached information associated with each other when the necessity information for the attached information does not satisfy a predetermined condition and ii) transmits the body information and the attached information associated with each other when the necessity information for the attached information satisfies the condition.
